(19) United States
(12) Patent Application Publication
(10) Pub. No.: US 2024/0078469 A1
(43) Pub. Date: Mar. 7, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: AYUTA KAWAZU, Kanagawa (JP); NOBUHIRO TAGASHIRA, Chiba (JP); TAKAMI EGUCHI, Tokyo (JP); YUKI MINETOMO, Kanagawa (JP)

(21) Appl. No.: 18/453,179

(22) Filed: Aug. 21, 2023

(30) Foreign Application Priority Data
Sep. 2, 2022 (JP) 2022-140387

(51) Int. Cl. G06N 20/00

(52) U.S. Cl. CPC G06N 20/00

(57) ABSTRACT

An information processing apparatus includes a holding unit configured to hold first input data having a plurality of fields, for use in machine learning, a generation unit configured to generate second input data having a plurality of fields, for use in the machine learning, based on the first input data, and an adjustment unit configured to adjust values stored in the plurality of fields in the second input data.

### BACKGROUND

### Field of the Disclosure

The present disclosure relates to an information processing apparatus for generating data for machine learning, an information processing method, and a storage medium.

### Description of the Related Art

In recent years, for the purpose of improving the training efficiency/accuracy of a machine learning model, a plurality of technologies that generates/expands training data for machine learning based on a small amount of actually acquired data (hereinafter may be referred to as “real data”) has appeared.

For example, consider a case where a machine learning model that classifies/distinguishes a case with a small number of pieces of data (hereinafter may be referred to as “minor class”) such as a rare case and a case with a large number of pieces of data (hereinafter may be referred to as “major class”) such as influenza is to be constructed. In such a case, there is a possibility that training cannot be correctly performed because the numbers of pieces of data are not uniform between classes. As a technology for correcting such an ununiformity, there is a known technology called Synthetic Minority Oversampling Technique (SMOTE) for generating synthetic data from the real data of a minor class. The ununiformity between classes can be corrected by increasing the number of pieces of data of the minor class by adding data generated by SMOTE to training data of the minor class. Other known technologies used for data generation include Random Over-Sampling (ROS), and Variational Autoencoder (VAE) and Generative Adversarial Network (GAN) that are data generation models using machine learning.

In Japanese Patent Application Laid-Open No. 2021-174401, in order to increase training data for a machine learning model that generates a candidate for a compound structure representation having a desired physical property, chemical structure formulas of various patterns are generated as training data from structure formulas of a minor class, using VAE. In a case where the generated data does not conform to the grammar rule of Simplified Molecular Input Line Entry System (SMILES) that is a representational form of structural formula, the generated data is corrected to conform to the grammar rule of SMILES.

In Japanese Patent Application Laid-Open No. 2021-174401, however, there is a possibility that data generation is unstable because of insufficient training of VAE if the number of pieces of data is small. In a case where SMOTE is combined with the technology discussed in Japanese Patent Application Laid-Open No. 2021-174401 (in a case where SMOTE is used in place of VAE), data can be stably generated even if the number of pieces of data is small, because training is unnecessary. However, the technology discussed in Japanese Patent Application Laid-Open No. 2021-174401 performs only correction of inconsistency with respect to the grammar rule, as the correction. For this reason, for example, in a case where training data of a network packet is generated by combining the technology discussed in Japanese Patent Application Laid-Open No. 2021-174401 with SMOTE, the following issue arises. The network packet is usually composed of a packet header and a payload. In particular, the packet header is structured data which consists of a plurality of fields and in which a data format is defined. For example, an Internet Protocol (IP) packet header has a plurality of fields, according to a data format defined by the Internet Engineering Task Force (IETF). The plurality of fields includes, sequentially from the top of the header, “version field (size: 4 bits) storing IP version”, and “Internet Header Length (IHL) field (size: 4 bits) storing header length”. In this case, the above-described data format of the packet header can be a pre-defined data rule, and thus can be regarded as the grammar rule in Japanese Patent Application Laid-Open No. 2021-174401. Accordingly, in a case where the order of fields and the field sizes of the fields included in the packet header are different from the definition of the data format, it is conceivable that these are corrected by the technology of Japanese Patent Application Laid-Open No. 2021-174401, as inconsistency of the data format. However, unlike the pre-defined data format such as the order of fields and the field sizes of the fields, the value itself stored in the field of the packet header can be any value, and thus is not necessarily an appropriate value. For example, a checksum of the network packet, stored in a checksum field, is a value calculated from the entire packet, and thus can be any value.

### SUMMARY

In view of the above-described issue, the present disclosure is directed to generating input data having a plurality of fields, as data suitable for machine learning.

An information processing apparatus includes a holding unit configured to hold first input data having a plurality of fields, for use in machine learning, a generation unit configured to generate second input data having a plurality of fields, for use in the machine learning, based on the first input data, and an adjustment unit configured to adjust values stored in the plurality of fields in the second input data.

Further features of the present disclosure will become apparent from the following description of exemplary embodiments with reference to the attached drawings.

### BRIEF DESCRIPTION OF THE DRAWINGS

FIG. 1 is a block diagram illustrating an example of a configuration of an information processing apparatus.

FIG. 2 is a block diagram illustrating an example of a functional configuration of the information processing apparatus according to one or more aspects of the present disclosure.

FIGS. 3A and 3B illustrate packet data and a packet header, respectively.

FIGS. 4A, 4B, and 4C illustrate an adjustment table according to one or more aspects of the present disclosure, an adjustment table according to one or more aspects of the present disclosure a second modification and a third modification, and a consistency verification table according to a fourth modification, respectively.

FIG. 5 is a diagram illustrating a collective replacement template according to a first modification.

FIGS. 6A and 6B are flowcharts illustrating processing according to the first exemplary embodiment.

FIGS. 7A and 7B are flowcharts illustrating processing according to the fourth modification.

### DESCRIPTION OF THE EMBODIMENTS

Information processing in exemplary embodiments according to the present disclosure will be described in detail below with reference to the drawings. A first exemplary embodiment will be described.

### (Apparatus Configuration in First Exemplary Embodiment)

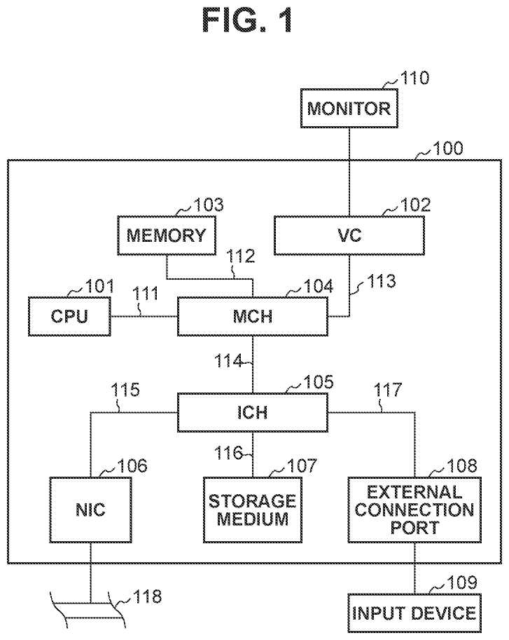

FIG. 1 is a block diagram illustrating an example of a configuration of an information processing apparatus 100 according to the first exemplary embodiment. A central processing unit (CPU) 101 executes a program stored in a memory 103 or a storage medium 107, using the memory 103 as a work memory, and controls the whole or a part of the operation of the information processing apparatus 100. The memory 103 includes a random access memory (RAM) and a read only memory (ROM). A display controller (VC) 102 controls display of a screen including an image and/or text on a monitor 110, based on an instruction from the CPU 101.

A memory controller hub (MCH) 104 is a so-called “northbridge” that controls data transfer between the CPU 101, the VC 102, the memory 103, and an input/output controller hub (ICH) 105, via links 111 to 114. The ICH 105 is a so-called “southbridge” that controls data transfer between a network interface card (NIC) 106, the storage medium 107, and an external connection port 108, via links 115 to 117. Each of the links 111 to 117 is, for example, a parallel bus based on Peripheral Component Interconnect (PCI) or PCI Express, or a serial bus based on Serial AT attachment (SATA) or Universal Serial Bus (USB).

The NIC 106 is a communication interface for connection to a wired or wireless network 118. The storage medium 107 stores an operating system (OS), various programs, various data, and the like to be executed by the CPU 101. The external connection port 108 is a port of a bus based on, for example, USB or the Institute of Electrical and Electronics Engineers (IEEE) 1394, for connecting an external device to the information processing apparatus 100. The information processing apparatus 100 can acquire data from an input device 109, by connecting the input device 109 to the external connection port 108. The input device 109 is a device for inputting data into the information processing apparatus 100 via the external connection port 108, and examples of the input device 109 include a keyboard, a pointing device such as a mouse, an image capturing device such as a digital camera, and an image input device.

The information processing apparatus 100 can be implemented by supplying a program for executing processing to be described below to an Internet of Things (IoT) device, such as a digital camera, a printer, a network camera, a smartphone, or a personal computer (PC).

A functional configuration and a series of processes of generating consistent training data for machine learning in the present exemplary embodiment will be described.

### (Functional Configuration in First Exemplary Embodiment)

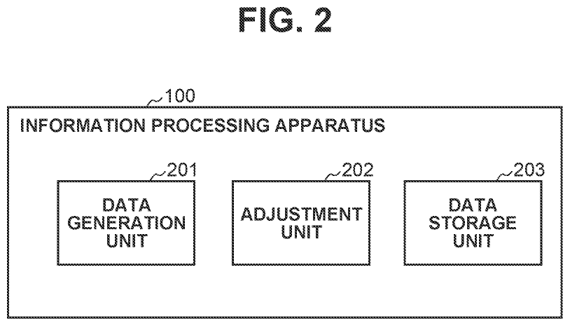

An example of a functional configuration of the information processing apparatus 100 of the first exemplary embodiment will be described with reference to a block diagram in FIG. 2. The CPU 101 executes an information processing program of the first exemplary embodiment, so that the functional configuration is implemented.

In the present exemplary embodiment, network packet data will be described below as training data to be generated, but the training data to be generated in the present exemplary embodiment is not limited to the network packet data.

A data generation unit 201 generates, based on input data, new input data approximate to the input data, using a data generation algorithm. In the following, the new input data to be generated will be referred to as second input data, and the input data used for generating the second input data will be referred to as first input data, as appropriate.

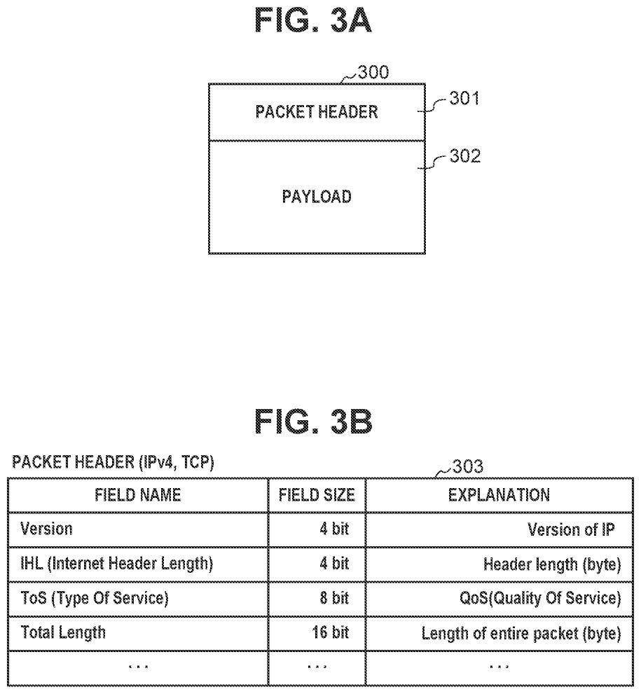

The first input data is, for example, network packet data acquired using packet capture or the like, and is held in a data storage unit 203 to be described below. The network packet data will be described with reference to FIGS. 3A and 3B. As illustrated in FIG. 3A, typically, packet data 300 is composed of a packet header 301 in which basic information about a packet is stored, and a payload 302 that is a transmission data body. The payload 302 is encrypted by encrypted communication based on Transport Layer Security (TLS) or the like, and thus only the packet header 301 is used as the training data in machine learning. The packet header 301 is structured data in which a data format is defined by the Internet Engineering Task Force (IETF) as described above. For example, in the case of a packet header of Internet Protocol Version 4 (IPv4) and Transmission Control Protocol (TCP), the packet header is composed of fields indicated by a table 303 in FIG. 3B. The table 303 indicates, in order of storage from the top of the packet header, “field name”, “field size”, and “explanation” of a value to be stored in a field, of each field of the packet header. In other words, the first 4 bits of the packet header 301 contain a version field storing the version of the IP, and the next 4 bits contain an Internet Header Length (IHL) field storing the header length of the packet. The table 303 indicates only some of the fields included in the packet header. A plurality of other fields, such as a protocol field, a destination port field, a checksum field, an acknowledgement number field, a sequence number field, and a flags field, is also included.

As a data generation algorithm for generating the second input data, known technologies, such as Synthetic Minority Oversampling Technique (SMOTE), Variational Autoencoder (VAE), or Generative Adversarial Network (GAN) described above can be used. VAE and GAN are data generation algorithms using machine learning, and thus it is desirable to perform training beforehand. On the other hand, SMOTE is an algorithm for generating new data using the internal division point of a plurality of pieces of input data, as synthetic data. SMOTE is not a machine learning model, and thus training is unnecessary unlike VAE and GAN, and data can be stably generated. However, in SMOTE, data is generated by simple data synthesis, and thus inconsistency of values stored in fields easily occurs.

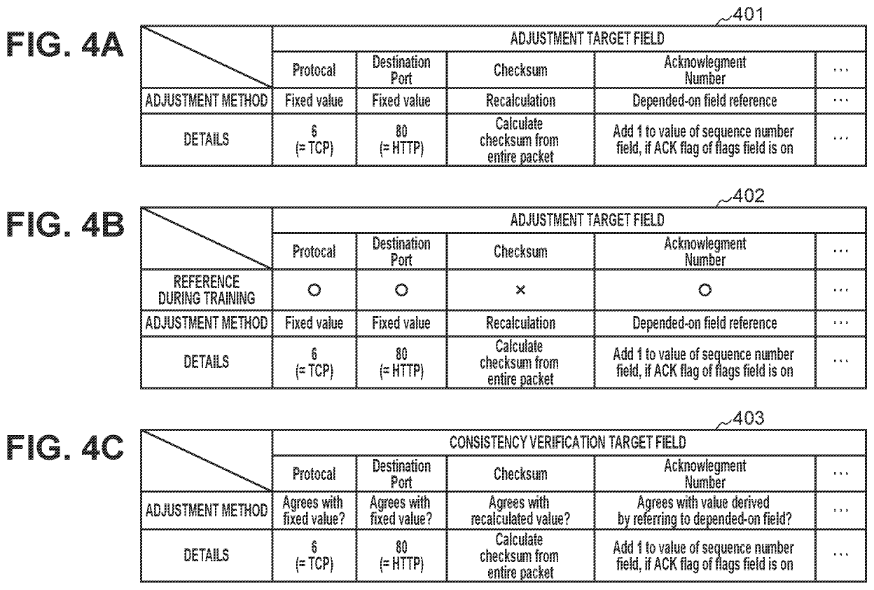

An adjustment unit 202 corrects inconsistency of the second input data generated by the data generation unit 201. Specifically, using an adjustment table 401 illustrated in FIG. 4A to be described below, the adjustment unit 202 corrects inconsistency of the data generated by the data generation unit 201, by changing a value to be stored in a field so as to achieve consistency, for a field for which it is desirable to achieve consistency. As describe above, data to be handled will be described below as the network packet data. FIG. 4A illustrates the adjustment table 401 in which a field name, an adjustment method, and the details of the adjustment method are recorded for each field to be adjusted. Examples of the adjustment method include “a method of replacing a value with a specific fixed value”, “a method of changing a value to a value recalculated based on a calculating formula”, and “a method of changing a value to a value calculated with reference to a depended-on another field”. For example, the adjustment unit 202 refers to the adjustment table 401. The adjustment unit 202 changes the value of the protocol field so that a value to be stored in the protocol field of the packet data generated by the data generation unit 201 is 6 (=a value indicating TCP) that is a fixed value. For the checksum field, the adjustment method is “recalculation”, and thus the checksum is calculated again from the entire packet as described in the details column. The checksum field is adjusted by storing the calculated value into the checksum field. For the acknowledgment number field, the adjustment method is “depended-on field reference”, and thus an ACK flag of the flags field that is a depended-on field is confirmed as described in the details column. In a case where the flag is on, the acknowledgment number field is adjusted by storing a value obtained by adding 1 to the value of the sequence number field into the acknowledgment number field.

In this way, for each field included in the second input data generated by the data generation unit 201, the adjustment unit 202 changes the value stored in the field with reference to the adjustment table 401, thereby correcting inconsistency of the data. To be more specific, for example, the following processing is performed. For the top field (the version field in the case of the IPv4 packet) of the packet data, the adjustment unit 202 checks whether this field is an adjustment target field, with reference to the adjustment table 401. In a case where the field is an adjustment target field, adjustment is performed by the adjustment method. In a case where the field is not an adjustment target field, adjustment is not performed. Upon completion of these steps, the processing target shifts to the next field. Inconsistency of all the fields included in the second input data can be corrected by performing this processing on all the fields sequentially from the top field.

The adjustment table 401 described above is merely an example. For example, the IHL field may be used as the adjustment target field. Also as the adjustment method, other methods including a method of replacement by a value derived by an artificial intelligence (AI) technology may be used. The data adjusted by the adjustment unit 202 is held in the data storage unit 203 to be described below, as the training data.

The data storage unit 203 stores data to and reads out data from the storage medium 107 in response to requests from other control unit. As described above, for example, the data input to the data generation unit 201, the data generated by the data generation unit 201, and the data adjusted by the adjustment unit 202 are held in the data storage unit 203. This completes the description of the functional configuration in the present exemplary embodiment.

### (Series of Processes in First Exemplary Embodiment)

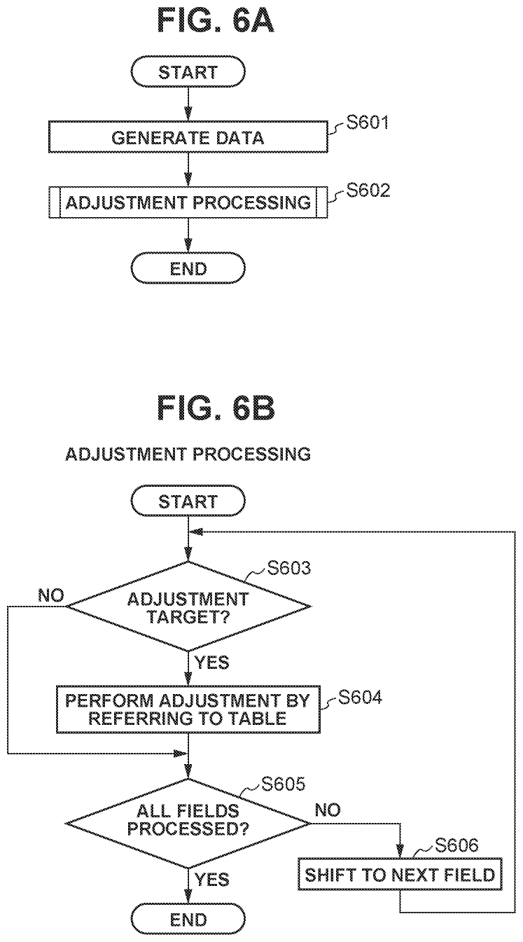

Processing of generating training data for machine learning having consistency in the present exemplary embodiment will be described with reference to a flowchart in each of FIGS. 6A and 6B.

First, a series of basic processes of the present exemplary embodiment will be described with reference to FIG. 6A.

In step S601, the data generation unit 201 generates data based on input data. In step S602, the adjustment unit 202 adjusts the data generated by the data generation unit 201.

The adjustment processing in step S602 will be described with reference to FIG. 6B. Here, the adjustment processing for one piece of data will be described as an example.

In step S603, for a field of the data generated by the data generation unit 201, the adjustment unit 202 determines whether this field is an adjustment target field, with reference to the adjustment table 401. In a case where this field is an adjustment target field (YES in step S603), the processing proceeds to step S604. In step S604, the adjustment unit 202 performs adjustment on a value to be stored in this field, with reference to the adjustment table 401. In a case where the adjustment unit 202 determines that this field is not an adjustment target field (NO in step S603), adjustment is not performed, and the processing proceeds to step S605 to determine whether all the fields are processed. In a case where there is an unprocessed field (NO in step S605), the processing proceeds to step S606. In step S606, the processing target shifts to the next field, and subsequently the processing returns to step S603. This processing is performed until all the fields are processed (YES in step S605).

The adjustment processing for one piece of data is described, but in a case where adjustment of a plurality of pieces of data is performed, the adjustment can be implemented by performing the adjustment processing in step S602 on each of these pieces of data.

In this way, in the present exemplary embodiment, the training data having consistency is generated by performing the adjustment processing on the data generated using the data generation algorithm, so that an improvement in accuracy of a machine learning model can be expected.

A first modification of the first exemplary embodiment will be described. In the present modification, all adjustment target fields each having a fixed value are collectively replaced using a collective replacement template to be described below, so that a speedup in adjustment is realized.

In the first exemplary embodiment, the adjustment unit 202 checks, for each field, whether the field is an adjustment target field, and performs adjustment by the adjustment method, using the adjustment table 401. In the present modification, a plurality of fields for each of which the adjustment method is replacement with a fixed value is collectively adjusted, using a template for collective replacement to be described below, in which the field name, the field size, the field position, and the fixed value for replacement, of an adjustment target field, are listed.

In the present modification, a function different from the first exemplary embodiment will be described.

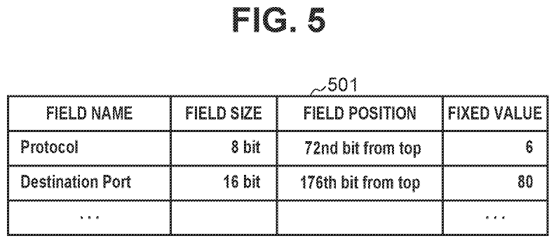

In the present modification, the adjustment unit 202 performs adjustment by collectively replacing a plurality of fields included in target data with a fixed value, using the collective replacement template. For example, as illustrated in FIG. 5, in a collective replacement template 501, “field name”, “field size”, “field position”, and “fixed value (a replacing value in adjustment)” are listed for every field to be adjusted using a fixed value. The “field position” is an offset value indicating the position of the relevant field counted from the top of the packet data. For example, the protocol field is present as an area having a size of 8 bits, at the 72nd bit from the top, according to the collective replacement template 501. Therefore, the protocol field is adjusted by overwriting this area with 6 that is the fixed value. In this way, the adjustment unit 202 identifies a target field area based on the field position and the field size of each of all the fields to be adjustment targets, with reference to the collective replacement template 501, and overwrites the value stored in the identified area with the fixed value, thereby performing collective adjustment.

This makes it unnecessary for the adjustment unit 202 to scan all the fields unlike the first exemplary embodiment, and makes it possible to adjust the data only by performing the processing of overwriting the value with the fixed value for the area identified using the collective replacement template 501, so that a speedup in processing can be expected.

A second modification of the first exemplary embodiment will be described. In the present modification, only a field to be referred to during machine learning is adjusted, so that a speedup in processing is realized.

In machine learning, there is a case where only a field with a high contribution to training is used for training, and all other fields with a low contribution or no contribution to training are not referred to. In this case, it is not necessary to adjust all the fields with a low contribution or no contribution to training that are not to be referred to, and therefore, a speedup in adjustment processing can be expected by excluding these fields from adjustment target fields beforehand. For example, suppose that, in a case where a machine learning model determines an environment (e.g., a public space, home, or office) for installation of an information processing apparatus based on a network packet, the checksum field cannot be a determining factor for determining the installation environment. In this case, the checksum field is excluded from the adjustment target fields beforehand, as a field with a low contribution or no contribution to training.

In the present modification, a function different from that in the first exemplary embodiment and the first modification thereof will be described.

In the present modification, the adjustment unit 202 identifies a field to be referred to during training, with reference to an adjustment table 402 illustrated in FIG. 4B, and performs adjustment only on this field. The adjustment table 402 in FIG. 4B is a table obtained by adding information about reference during training to the adjustment table 401 in FIG. 4A. For example, the protocol field in which the reference during training is “applicable” is also referred to during training as a field with a high contribution to training, and thus adjustment is performed on this field. On the other hand, the checksum field in which the reference during training is “not applicable” is not referred to during training as a field with a low contribution or no contribution, and thus adjustment is not performed on this field.

In this way, in the present modification, the adjustment is performed only on the field to be referred to during training in machine learning, and therefore, a speedup in the adjustment processing can be expected.

A third modification of the first exemplary embodiment will be described. In the present modification, the data generation algorithm used in the data generation unit 201 is limited to an algorithm not using machine learning. As described above, in a data generation algorithm not using machine learning such as SMOTE, data can be stably generated because learning itself is unnecessary, but inconsistency of data easily occurs because data is generated from synthetic data. Accordingly, the adjustment unit 202 performs adjustment on data generated by the data generation unit 201 by use of the data generation algorithm not using machine learning, so that both of stable data generation and generation of consistent data can be realized. SMOTE described as the data generation algorithm not using machine learning is merely an example. For example, Random Over-Sampling (ROS) described above as a known technology, which is similarly an algorithm not using machine learning, can also be used.

A fourth modification of the first exemplary embodiment will be described. In the present modification, consistency of each field is verified, and data having an inconsistent field is excluded from training data.

In other words, among pieces of data generated by the data generation unit 201, only consistent pieces of data are used as the training data. The adjustment unit 202 performs consistency verification processing of determining whether data is consistent, as will be described below. This can decrease the number of pieces of training data, but a speedup in processing can be expected because adjustment with reference to an adjustment table is not performed.

In the present modification, a function different from that in the first exemplary embodiment will be described with reference to FIG. 4C.

FIG. 4C illustrates a consistency verification table 403 in which a consistency verification method and the details of the consistency verification method are listed for each field to be a consistency verification target, in the present modification. The adjustment unit 202 performs the consistency verification processing on the data generated by the data generation unit 201, based on the consistency verification table 403. For example, the adjustment unit 202 verifies whether a value stored in the protocol field of the packet data generated by the data generation unit 201 agrees with a fixed value described in the consistency verification method, with reference to the consistency verification table 403. The fixed value is 6 (=a value indicating TCP). In a case where the stored value does not agree with the fixed value, this data is excluded from the training data, as inconsistent data. The consistency verification methods for other fields are, likewise, verification methods using the adjustment methods described with reference to the adjustment table 401 of the first exemplary embodiment, and thus, the description thereof will be omitted. As the method of excluding inconsistent data from the training data, various methods, such as a method of deleting the data as a file and a method of moving the data from a folder storing training data to another folder, can be used.

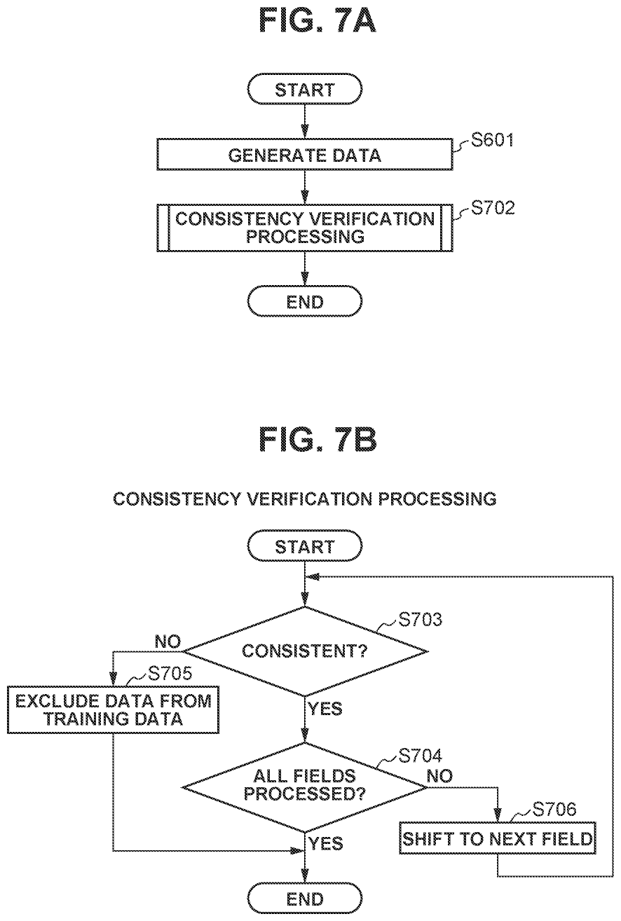

In the present modification, a series of processes different from the first exemplary embodiment will be described with reference to FIGS. 7A and 7B. Steps substantially similar to those in the first exemplary embodiment are denoted by the same reference numerals as those in the first exemplary embodiment, and the description thereof will be omitted. First, a series of basic processes of the present modification will be described with reference to FIG. 7A. In step S702, the adjustment unit 202 performs consistency verification on the data generated by the data generation unit 201. The consistency verification processing in step S702 will be described with reference to FIG. 7B. Here, the consistency verification processing to be performed on one piece of data will be described as an example, as with the first exemplary embodiment.

In step S703, the adjustment unit 202 determines whether a field of the data generated by the data generation unit 201 is consistent, with reference to the consistency verification table 403. In a case where the field is not consistent (NO in step S703), the processing proceeds to step S705. In step S705, the data is excluded from the training data, as inconsistent data. In a case where the field is consistent (YES in step S703), the processing proceeds to step S704 to determine whether all the fields are processed. In a case where there is an unprocessed field (NO in step S704), the processing proceeds to step S706. In step S706, the processing target shifts to the next field, and subsequently the processing returns to step S703. This processing is performed until all the fields are processed (YES in step S704).

Here, the consistency verification processing on one piece of data is described, but in a case where a plurality of pieces of data is to be subjected to the consistency verification processing, the verification can be implemented by performing the consistency verification processing in step S702 on each of these pieces of data.

Other modifications will be described. In the first exemplary embodiment and the first and second modifications described above, the adjustment unit 202 identifies the adjustment target field by scanning each field using the adjustment table 401 or 402. In the fourth modification described above, the adjustment unit 202 identifies the consistency verification target field by scanning each field using the consistency verification table 403. However, the target field may be directly referred to, by including the field position in each of the tables, as with the collective replacement template 501 of the first modification. In this case, the field position of each field is listed in the tables 401, 402, and 403 illustrated in FIGS. 4A, 4B, and 4C, respectively. This enables the adjustment unit 202 to directly refer to the adjustment target field or the consistency verification target field, in the first exemplary embodiment and the second, third, and fourth modifications, as with the first modification. Accordingly, it is unnecessary to scan all fields, so that a speedup in the processing can be expected.

In the above-described first exemplary embodiment and modifications of the first exemplary embodiment, the IPv4 TCP packet is used as the network packet, but this is merely an example. For example, the present disclosure is also applicable to a User Datagram Protocol (UDP) packet and an Internet Protocol version 6 (IPv6) packet.

In the above-described first exemplary embodiment and modifications of the first exemplary embodiment, only the packet header of the network packet is described, but adjustment may be similarly performed on the payload.

In the above-described first exemplary embodiment and modifications of the first exemplary embodiment, the methods using the fixed value, the recalculation, and the depended-on field reference are described as the adjustment method, but these are merely examples. For example, an adjustment method employing an AI technology using machine learning may be used.

In the first exemplary embodiment and the second, third, and fourth modifications described above, the method of scanning each field sequentially from the top field in the adjustment unit 202 is described, but this is merely an example. For example, fields may be scanned in a different order, such as the reverse order from the last field. In yet another example, fields that are not referred to may be sequentially operated first, in consideration of the depended-on field reference.

In the first exemplary embodiment and the second, third, and fourth modifications described above, the order of fields to be scanned by the adjustment unit 202 may be changed depending on the adjustment method. For example, there is a case where, when a field for which the adjustment method is “recalculation” is adjusted, the recalculation is performed with reference to values stored in other adjustment target fields. In this case, more accurate adjustment can be implemented for the field for which the adjustment method is “recalculation”, by performing the recalculation after the other adjustment target fields to be referred to in the recalculation are adjusted using a fixed value and the like. Similarly, concerning a field for which the adjustment method is “depended-on field reference”, there is a case where a depended-on field is included in adjustment target fields. In this case as well, more accurate adjustment can be implemented for the field for which the adjustment method is “depended-on field reference”, by performing the adjustment after the depended-on field is adjusted.

In the above-described second modification, whether to exclude the field from the adjustment targets may be changed depending on the adjustment method. For example, suppose there is a field A for which the adjustment method is “depended-on field reference” and the reference during training is “applicable”, as an adjustment target field. Further, suppose the adjustment target field to be referred to by the field A as the depended-on field is a field B, and the reference during training of the field B is “not applicable”. In this case, the field B is not adjusted, because the reference during training is “not applicable”. In other words, the field A is adjusted with reference to the field B while the value of the field B remains inconsistent, so that there is a possibility that the field A is not appropriately adjusted. Accordingly, in such a case, the field A for which the adjustment method is “depended-on field reference” can also be appropriately adjusted by changing the field B that is the depended-on field to be also adjusted. This is merely an example, and a field for which the adjustment method is “recalculation” may be similarly treated. Specifically, in a case where a field for which the reference during training is “not applicable” is included in fields to be referred to in the recalculation, a correct recalculation result can be obtained by changing this field to be also adjusted.

In the above-described first exemplary embodiment and modifications of the first exemplary embodiment, the network packet data that is the structured data in which the data format is defined is described as an example of the data to be generated and the data to be adjusted, but this is merely an example, and other structured data can also be used.

For example, data compressed by ZIP (hereinafter referred to as the ZIP file) that is a known data compression format is structured data having a header in which a data format is defined, as with the above-described packet header. The header of the ZIP file has a plurality of fields, as with the packet header. For example, as a field storing a signature of a local file header, a “local file header signature” field having a field size of 4 bytes is held as the top of the header. As other fields, the header of the ZIP file also has a plurality of fields in which a data format is defined, such as a “version needed to extract” field having a field size of 2 bytes, which is a field storing the lowest version of ZIP for decompression. For example, a table for adjustment such as the adjustment table 401 in FIG. 4A is prepared for a field of the header of the ZIP file, so that the adjustment unit 202 can perform adjustment for the ZIP file, as with the network packet. For example, a table, in which a “version needed to extract” field is listed as an adjustment target field, and changing to “6.3” that is a fixed value is listed as the adjustment method of this field, may be prepared as the table for the adjustment of the ZIP file. The present disclosure can also be applied to data other than the network packet data and the ZIP file described above, as long as the data is the structured data in which the data format is defined as described above.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-140387, filed Sep. 2, 2022, which is hereby incorporated by reference herein in its entirety.

What is claimed is:

1. An information processing apparatus comprising:
a holding unit configured to hold first input data having a plurality of fields, for use in machine learning;
a generation unit configured to generate second input data having a plurality of fields, for use in the machine learning, based on the first input data; and
an adjustment unit configured to adjust values stored in the plurality of fields in the second input data.

2. The information processing apparatus according to claim 1, wherein the adjustment unit adjusts the values stored in the plurality of fields in the second input data, using a table in which field names of a target and an adjustment method for each of the field names of the target are recorded.

3. The information processing apparatus according to claim 2, wherein the adjustment method is at least one of replacement by a fixed value, replacement by a recalculated value, and replacement by a value calculated with reference to a value stored in a depended-on field.

4. The information processing apparatus according to claim 1,
wherein the first input data is network packet data, and
wherein the plurality of fields is a plurality of fields in a packet header in network packet data.

5. The information processing apparatus according to claim 1, wherein the adjustment unit adjusts the values stored in the plurality of fields in the second input data, using a table in which a field name, a field size, a field position, and a fixed value for replacement in adjustment, of a target, are recorded.

6. The information processing apparatus according to claim 1, wherein the adjustment unit adjusts a value stored in a field to be referred to in the machine learning, among the values stored in the plurality of fields in the second input data.

7. The information processing apparatus according to claim 1, wherein the adjustment unit does not use an inconsistent value in the machine learning, among the values stored in the plurality of fields in the second input data.

8. The information processing apparatus according to claim 1, wherein the generation unit generates the second input data having the plurality of fields, by use of a data generation algorithm not using machine learning, based on the first input data.

9. An information processing method comprising:
holding first input data having a plurality of fields, for use in machine learning;
generating second input data having a plurality of fields, for use in the machine learning, based on the first input data; and
adjusting values stored in the plurality of fields in the second input data.

10. A non-transitory storage medium storing a program causing an information processing apparatus to execute an information processing method, the information processing method comprising:
holding first input data having a plurality of fields, for use in machine learning;
generating second input data having a plurality of fields, for use in the machine learning, based on the first input data; and
adjusting values stored in the plurality of fields in the second input data.
